(19) United States
(12) Patent Application Publication
(10) Pub. No.: US 2011/0058678 A1
(43) Pub. Date: Mar. 10, 2011

(54) STEREO SIGNAL CONVERSION DEVICE, STEREO SIGNAL INVERSE CONVERSION DEVICE, AND METHOD THEREOF

(75) Inventor: Toshiyuki Morll, Kanagawa (JP)

(73) Assignee: PANASONIC CORPORATION, Osaka (JP)

(21) Appl. No.: 12/990,819

(22) PCT Filed: May 21, 2009
(86) PCT No.: PCT/JP2009/002238

§ 371 Date: Nov. 3, 2010

(30) Foreign Application Priority Data
May 22, 2008 (JP) 2008-134140

(51) Int. Cl. H04R 5/00

(52) U.S. Cl. 381/17

(57) ABSTRACT

Provided is a stereo signal conversion device which can realize a high-quality encoding with few redundancy and with a low bit rate even when the position of a sound source is different. The device includes: a sample difference analysis unit (111) which calculates a sample difference D having the highest correlation by using a signal obtained by temporally shifting a right channel signal by a sample difference d and a left channel signal; a sample difference encoding unit (112) which encodes the sample difference D; a slide unit (113) which temporally cyclically shifts the right channel signal by the sample difference D; and a sum difference calculation unit (114) which adds the left channel signal and the right channel signal after the cyclic shift so as to generate a monaural signal and subtracts the right channel signal after the cyclic shift from the left channel signal so as to generate a side signal.

### TECHNICAL FIELD

The present invention relates to a stereo signal converting apparatus, stereo signal inverse-converting apparatus and converting and inverse-converting methods used in an encoding apparatus and decoding apparatus that realize stereo speech coding.

### BACKGROUND ART

Speech coding is generally used for communication applications using narrowband speech of the telephone band (200 Hz to 3.4 kHz). Narrowband speech codec of monaural speech is widely used in communication applications including speech communication through mobile phones, remote conference devices and recent packet networks (e.g. the Internet).

In recent years, with broadbandization of communication networks, there is a demand for realistic sensation in speech communication and high quality of music. To meet this demand, speech communication systems using stereo speech coding techniques have been developed.

As a method of encoding stereo speech, there is a known conventional method of finding a monaural signal to represent a sum of the left channel signal and the right channel signal, finding a side signal to represent the difference between the left channel signal and the right channel signal, and encoding the monaural signal and side signal (see Patent Literature 1).

The left channel signal and the right channel signal represent sound heard by human ears, the monaural signal can represent the common part between the left channel signal and the right channel signal, and the side signal can represent the spatial difference between the left channel signal and the right channel signal.

There is a high correlation between the left channel signal and the right channel signal. Consequently, compared to the case of encoding the left channel signal and the right channel signal directly, it is possible to perform more suitable coding in accordance with features of a monaural signal and side signal by encoding the left channel signal and right channel signal converted into a monaural signal and side signal, so that it is possible to realize coding with less redundancy, low bit rate and high quality.

### Citation List

### Patent Literature

### PTL 1

Japanese Patent Application Laid-open No. 2001-255892

### SUMMARY OF INVENTION

### Technical Problem

However, even in a case where the left channel signal and the right channel signal share the same main elements, if the sources of these signals are not at the same distance from two microphones, a timing difference (e.g. phase difference or time difference) occurs due to different arrival times at these two microphones, and the correlation between the left channel signal and the right channel signal at the same time decreases. Therefore, when the left channel signal and the right channel signal are converted into a monaural signal and a side signal and then encoded simply, in a case where the sources are not at the same distance from those two microphones, the monaural signal and the side signal still including redundancy are quantized inefficiently.

It is therefore an object of the present invention to provide a stereo signal converting apparatus, stereo signal inverse-converting apparatus, and converting and inverse-converting methods for reducing redundancy and realizing coding with a low bit rate and high quality, even in a case where the sources are not at the same distance from two microphones.

### Solution to Problem

The stereo signal converting apparatus of the present invention employs a configuration having: an analyzing section that finds a timing difference where a correlation is the highest between a first channel signal and a second channel signal moved cyclically in a time domain, the first channel signal and the second channel signal forming a stereo signal; a sliding section that cyclically moves the second channel signal in the time domain based on the timing difference; a sum and difference calculating section that generates a monaural signal related to a sum of the first channel signal and the second channel signal moved cyclically, and a side signal related to a difference between the first channel signal and the second channel signal moved cyclically; and a first encoding section that encodes the timing difference.

The stereo signal inverse-converting apparatus of the present invention employs a configuration having: a reconstructed signal generating section that generates a reconstructed signal of a first channel signal and a reconstructed signal of a second channel signal moved cyclically in a time domain, using a reconstructed monaural signal and a reconstructed side signal, the reconstructed monaural signal decoding encoded data of a monaural signal related to a sum of the first channel signal and the second channel signal moved cyclically, the first channel signal and the second channel signal forming a stereo signal, and the reconstructed side signal decoding encoded data of a side signal related to a difference between the first channel signal and the second channel signal moved cyclically; an opposite-sliding section that cyclically moves the reconstructed signal of the second channel signal moved cyclically, in a temporally opposite direction; and a first decoding section that decodes encoded data of information indicating a value cyclically moving the second channel signal.

The stereo signal converting method of the present invention includes: an analyzing step of finding a timing difference where a correlation is the highest between a first channel signal and a second channel signal moved cyclically in a time domain, the first channel signal and the second channel signal forming a stereo signal; a sliding step of cyclically moving the second channel signal in the time domain based on the timing difference; a sum and difference calculating step of generating a monaural signal related to a sum of the first channel signal and the second channel signal moved cyclically, and a side signal related to a difference between the first channel signal and the second channel signal moved cyclically; and a first encoding step of encoding the timing difference.

The stereo signal inverse-converting method of the present invention includes: a reconstructed signal generating step of generating a reconstructed signal of a first channel signal and a reconstructed signal of a second channel signal moved cyclically in a time domain, using a reconstructed monaural signal and a reconstructed side signal, the reconstructed monaural signal decoding encoded data of a monaural signal related to a sum of the first channel signal and the second channel signal moved cyclically, the first channel signal and the second channel signal forming a stereo signal, and the reconstructed side signal decoding encoded data of a side signal related to a difference between the first channel signal and the second channel signal moved cyclically; an opposite-sliding step of cyclically moving the reconstructed signal of the second channel signal moved cyclically, in a temporally opposite direction; and a decoding step of decoding encoded data of information indicating a value cyclically moving the second channel signal.

### ADVANTAGEOUS EFFECTS OF INVENTION

According to the present invention, even in a case where the sources of the left channel signal and the right channel signal are not at the same distance from two microphones and therefore there is a timing difference, by generating a monaural signal and a side signal after cyclically moving one of the left signal and the side signal in the time domain, it is possible to reduce redundancy and realize coding with a low bit rate and high quality.

### BRIEF DESCRIPTION OF DRAWINGS

FIG. 1 is a block diagram showing the configuration of an encoding apparatus including a stereo signal converting apparatus according to an embodiment of the present invention;

FIG. 2 illustrates processing in a sum and difference calculating section of a stereo signal converting apparatus according to an embodiment of the present invention;

FIG. 3 is a block diagram showing the configuration of a decoding apparatus including a stereo signal inverse-converting apparatus according to an embodiment of the present invention; and

FIG. 4 illustrates processing in a sum and difference calculating section of a stereo signal inverse-converting apparatus according to an embodiment of the present invention.

### DESCRIPTION OF EMBODIMENT

An embodiment of the present invention will be explained below in detail with reference to the accompanying drawings. Here, an example case will be explained with the present embodiment where a stereo signal is comprised of two signals of the left channel signal and the right channel signal. Also, the left channel signal, the right channel signal, the monaural signal and the side signal are represented by “L,” “R,” “M” and “S,” respectively, and their reconstructed signals are represented by “L′,” “R′,” “M” and “S′,” respectively.

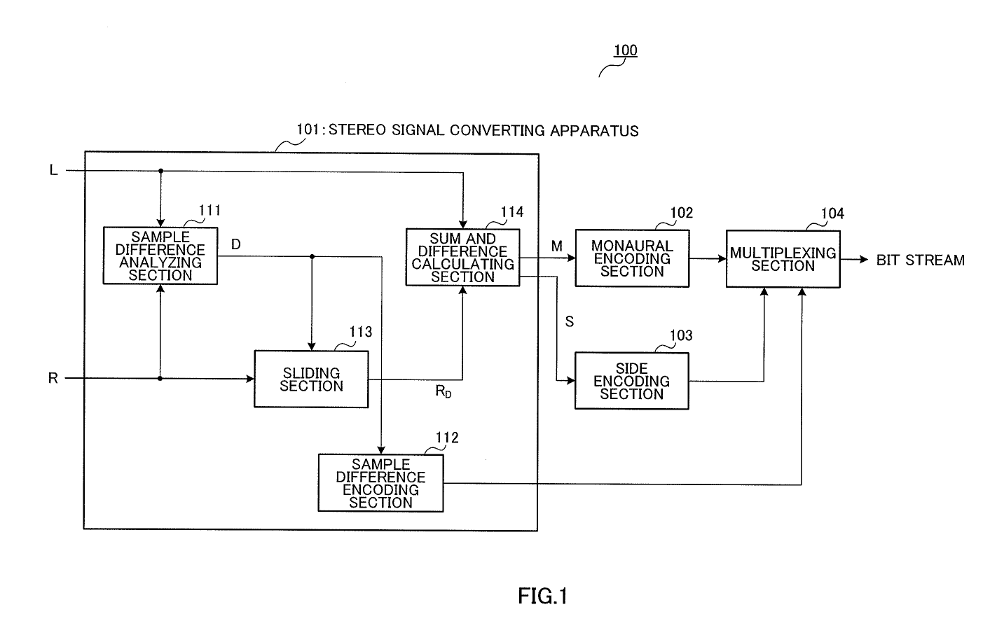

FIG. 1 is a block diagram showing the configuration of an encoding apparatus including a stereo signal converting apparatus according to the present embodiment. Encoding apparatus 100 shown in FIG. 1 is mainly provided with stereo signal converting apparatus 101, monaural encoding section 102, side encoding section 103 and multiplexing section 104.

Stereo signal converting apparatus 101 cyclically moves one of left channel signal L and right channel signal R in the time domain, and then generates monaural signal M, which is a sum of those signals, and side signal S, which is the difference between those signals. Then, stereo signal converting apparatus 101 outputs monaural signal M to monaural encoding section 102 and outputs side signal S to side encoding section 103. Also, stereo signal converting apparatus 101 encodes a value cyclically moving right channel signal R in the time domain (hereinafter, this value is referred to as “sample difference” and represented by “D”), and outputs the result to multiplexing section 104. Here, sample difference D will be described in detail in the explanation of the configuration inside stereo signal converting apparatus 101.

Monaural encoding section 102 encodes monaural signal M and outputs resulting encoded data to multiplexing section 104. Side encoding section 103 encodes side signal S and outputs resulting encoded data to multiplexing section 104.

Multiplexing section 104 multiplexes the encoded data of monaural signal M, the encoded data of side signal S and the encoded data of sample difference D, and outputs resulting bit streams.

Next, the configuration inside stereo signal converting apparatus 101 will be explained. Stereo signal converting apparatus 101 is provided with sample difference analyzing section 111, sample difference encoding section 112, sliding section 113 and sum and difference calculating section 114. Also, FIG. 1 shows a case where left channel signal L is fixed. In a case of fixing right channel signal R, an input of left channel signal L and an input of right channel signal R are inversed from each other.

Sample difference analyzing section 111 analyzes and finds sample difference (i.e. timing difference) D in which the correlation between left channel signal L and right channel signal R is the highest, and outputs sample difference D to sample difference encoding section 112 and sliding section 113. For example, according to following equation 1, sample difference analyzing section 111 calculates correlation value V_{d} between one frame of input left channel signal L and a signal acquired by cyclically moving one frame of input right channel signal R by sample difference d, and power C_{d} of right channel signal R at that time, and finds evaluation value E_{d}. Here, in equation 1, X*^{R} represents the signal value of right channel signal R at sample timing i, X*^{L} represents the signal value of left channel signal L at sample timing i, X⁻_{di}^{R} represents the signal value at each sample timing i of a signal acquired by cyclically moving the right channel signal by sample difference d, and Len represents the frame length.

$$\begin{matrix}( Equation 1 ) & \\ {\overline{X}}_{di}^{R} = \{ \begin{matrix}{X}_{i - d}^{R} & ( 0 \leq i - d < Len ) \\ {X}_{i - d + Len}^{R} & ( i - d < 0 ) \\ {X}_{i - d - Len}^{R} & ( i - d \geq Len )\end{matrix} \\ ( i = 0 ∼ Len - 1 ) \\ {V}_{d} = {\sum }_{i = 0}^{Len} {X}_{i}^{L} \times {\overline{X}}_{di}^{R} \\ {C}_{d} = {\sum }_{i = 0}^{Len} {\overline{X}}_{di}^{R} \times {\overline{X}}_{di}^{R} \\ {E}_{d} = {V}_{d}^{2} / {C}_{d} & [ 1 ]\end{matrix}$$

In equation 1, since the correlation between left channel signal L and right channel signal R becomes higher when E_{d} is higher, sample difference analyzing section 111 calculates sample difference D in which that evaluation value E_{d} is the highest. For example, when the sampling rate is 16 kHz and the maximum interval between both human ears is assumed around 34 cm, from the fact that the velocity at which sound travels is 340 m/s, performance can be acquired at ±16 samples (−16 to +15), and, as an example, sample difference analyzing section 111 calculates sample difference D in which the evaluation value is the highest in this range.

Sample difference encoding section 112 encodes sample difference D outputted from sample difference analyzing section 111, and outputs the result to multiplexing section 104. For example, when sample difference D assumes a value between −16 and +15, sample difference encoding section 112 can convert a numerical value between 0 and 31, which is acquired by adding 16 to the assumed value, to a five-bit code.

As shown in following equation 2, sliding section 113 cyclically moves right channel signal R in the time domain by sample difference D calculated in sample difference analyzing section 111, and outputs cyclically-moved right channel signal R_{D} to sum and difference calculating section 114. Here, in equation 2, X⁻ᵢ^{R} represents the signal value at each sample timing i of a signal acquired by cyclically moving the right channel signal by sample difference D.

$$\begin{matrix}( Equation 2 ) & \\ {\overline{X}}_{i}^{R} = \{ \begin{matrix}{X}_{i - D}^{R} & ( 0 \leq i - D < Len ) \\ {X}_{i - D + Len}^{R} & ( i - D < 0 ) \\ {X}_{i - D - Len}^{R} & ( i - D \geq Len )\end{matrix} \\ ( i = 0 ∼ Len - 1 ) & [ 2 ]\end{matrix}$$

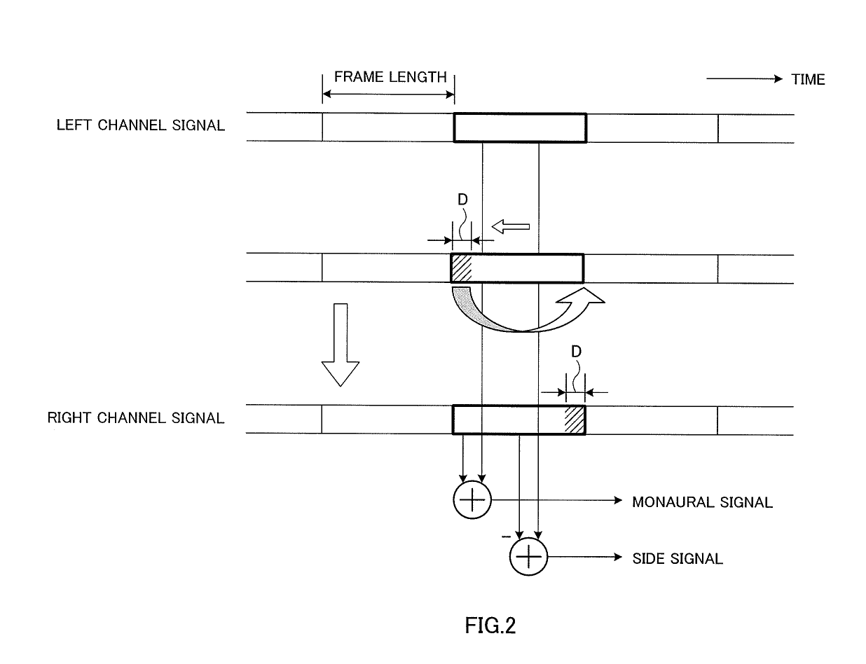

As shown in FIG. 2, sum and difference calculating section 114 generates monaural signal M by adding left channel L and cyclically-moved right channel signal R_{D}, and generates side signal S by subtracting cyclically-moved right channel signal R_{D} from left channel signal L. Further, sum and difference calculating section 114 outputs monaural signal M to monaural encoding section 102 and outputs side signal S to side encoding section 103. Equation 3 shows an example of calculations in sum and difference calculating section 114. In equation 3, Xᵢ^{M} represents the signal value of a monaural signal at sample timing i, and Xᵢ^{S} represents the signal value of a side signal at sample timing i.

[3]

Xᵢ^{M}=(Xᵢ^{L}+ X̅ᵢ^{R})×0.5

Xᵢ^{S}=(Xᵢ^{L}− X̅ᵢ^{R})×0.5 (Equation 3))

Thus, the present embodiment generates a monaural signal and a side signal after cyclically moving one of the left channel signal and the right channel signal in the time domain. By this means, even in a case where the sources of two signals are not at the same distance from two microphones and therefore there is a timing difference, it is possible to represent the main elements of the left channel signal and the right channel signal by a monaural signal more faithfully than the prior art, and represent the spatial difference between the left channel signal and the right channel signal by a side signal more faithfully than the prior art. Therefore, even in a case where there is a timing difference between two signals, it is possible to reduce redundancy and realize coding with a low bit rate and high quality.

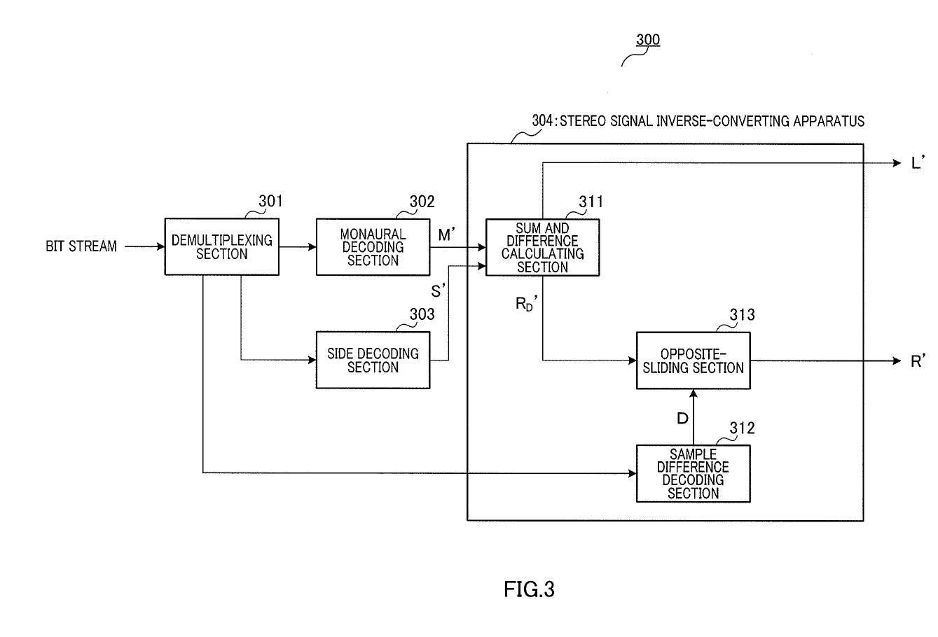

FIG. 3 is a block diagram showing the configuration of a decoding apparatus including a stereo signal inverse-converting apparatus according to the present embodiment. Decoding apparatus 300 shown in FIG. 3 is mainly formed with demultiplexing section 301, monaural decoding section 302, side decoding section 303 and stereo signal inverse-converting apparatus 304.

Demultiplexing section 301 demultiplexes bit streams received in decoding apparatus 300 and outputs encoded data of monaural signal M, encoded data of side signal S and encoded data of sample difference D to monaural decoding section 302, side decoding section 303 and stereo signal inverse-converting apparatus 304, respectively.

Monaural decoding section 302 decodes the encoded data of monaural signal M and outputs resulting, reconstructed monaural signal M′ to stereo signal inverse-converting apparatus 304. Side decoding section 303 decodes the encoded data of side signal S and outputs resulting, reconstructed side signal S′ to stereo signal inverse-converting apparatus 304.

Stereo signal inverse-converting apparatus 304 provides reconstructed left channel signal L′ and reconstructed right channel signal R′ using the encoded data of sample difference D, reconstructed monaural signal M′ and reconstructed side signal S′.

Next, the configuration inside stereo signal inverse-converting apparatus 304 will be explained. Stereo signal inverse-converting apparatus 304 is formed with sum and difference calculating section 311, sample difference decoding section 312 and opposite-sliding section 313. Here, FIG. 3 shows a case where reconstructed left channel signal L′ is fixed. When reconstructed right channel signal R′ is fixed, an input of reconstructed left channel signal L′ and an input reconstructed right channel signal R′ are inversed from each other in FIG. 3.

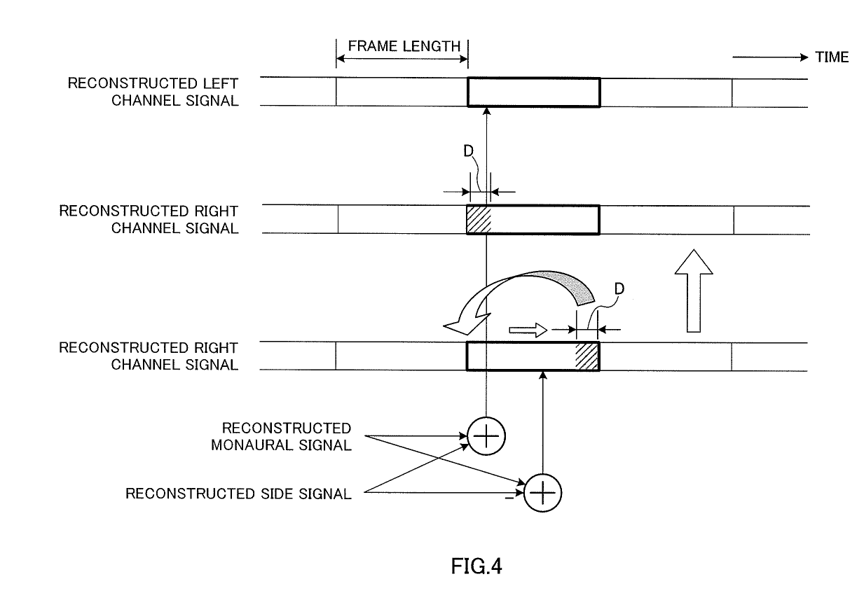

As shown in FIG. 4, according to following equation 4, sum and difference calculating section 311 calculates reconstructed left channel signal L′ and reconstructed right channel signal R_{D}′ subjected to cyclic movement, using reconstructed monaural signal M′ outputted from monaural decoding section 302 and reconstructed side signal S′ outputted from side decoding section 303. Here, in equation 4, Yᵢ^{M} represents the signal value at sample timing i of the reconstructed monaural signal, Yᵢ^{S} represents the signal value at sample timing i of the reconstructed side signal, Yᵢ^{L} represents the signal value at sample timing i of the reconstructed left channel signal, and Y⁻ᵢ^{R} represents the signal value at sample timing i of the reconstructed right channel signal subjected to cyclic movement.

[4]

Yᵢ^{L}=Yᵢ^{M}+Yᵢ^{S}

Y̅ᵢ^{R}=Yᵢ^{M}−Yᵢ^{S} (Equation 4)

Sample difference decoding section 312 decodes the encoded data of sample difference value D outputted from demultiplexing section 301, and outputs resulting sample difference D to opposite-sliding section 313.

As shown in following equation 5, opposite-sliding section 313 cyclically moves reconstructed right channel signal R_{D}′ subjected to cyclic movement, by sample difference D outputted from sample difference decoding section 312, in the direction opposite to the direction of time-domain cyclic movement in sliding section 113 of stereo signal converting apparatus 101. In other words, opposite-sliding section 313 cyclically moves reconstructed right channel signal R_{D}′ subjected to cyclic movement, to temporally match reconstructed left channel signal L′. Here, in equation 5, Y*^{R} represents the reconstructed right channel signal.

$$\begin{matrix}( Equation 5 ) & \\ {Y}_{i}^{R} = \{ \begin{matrix}{\overline{Y}}_{i + D}^{R} & ( 0 \leq i + D < Len ) \\ {\overline{Y}}_{i + D + Len}^{R} & ( i + D < 0 ) \\ {\overline{Y}}_{i + D - Len}^{R} & ( i + D \geq Len )\end{matrix} \\ ( i = 0 ∼ Len - 1 ) & [ 5 ]\end{matrix}$$

As described above, in a case where the sources of the left channel signal and the right channel signal are different in an encoding apparatus, the present invention generates a monaural signal and a side signal after cyclically moving one of the left channel signal and the right channel signal in the time domain, and encodes a time difference (corresponding to a sample difference) element separately. By this means, it is possible to represent the main elements of the left channel signal and the right channel signal by a monaural signal more faithfully than the prior art, and represent the spatial difference between the left channel signal and the right channel signal by a side signal more faithfully than the prior art. Therefore, even in a case where the sources of two signals are not at the same distance from two microphones and therefore there is the timing difference between those two signals, it is possible to reduce redundancy and realize coding with a low bit rate and high quality.

Also, with the present invention, by cyclically moving a signal in an encoding apparatus, it is possible to perform processing without taking care of the processing delay in decoding processing.

Also, although two stereo signals are expressed by the names “left channel signal” and “right channel signal,” it is equally possible to use more general names such as “first channel signal” and “second channel signal.”

Also, although a case has been described above with the embodiment where the left channel signal of a stereo signal is fixed, according to the present invention, it is equally possible to provide the above effect by fixing the right channel signal. In this case, the left channel signal and the right channel signal in the above embodiment are switched.

Also, although the range of a sample difference is ±16 in the above embodiment, the range of a sample difference is not limited in the present invention. By widening this range, the number of variations to express a delay increases, so that quality becomes high. In contrast, by narrowing this range, it is possible to reduce coding bits.

Also, although an integral value is used for a sample difference in the above embodiment, the present invention is not limited to this, and it is equally possible to use a fraction value as a sample difference. In this case, the fraction value is interpolated by, for example, an SINC function and then used. By using fraction values, it is possible to improve the accuracy of a time difference. However, there is a problem that, if the accuracy improves to ½ accuracy, ⅓ accuracy, and so on, the amount of calculations increases. Here, the inventor confirms that, if the sampling rate is 16 kHz, the effect is provided with integer accuracy. Also, the inventor confirms that the accuracy needs to be improved to, for example, ½ accuracy, in the case of 8 kHz sampling.

Also, according to the present invention, regardless of the sampling rate, it is possible to cope with all sampling rates of 8 kHz, 16 kHz, 32 kHz, 44.1 kHz, 48 kHz, and so on. Here, in the case of a sampling rate of 32 kHz or more, it is necessary to perform a search in a much wider range of a sample difference than ±16. Further, in this case, it is possible to interpolate many samples, so that it is possible to increase the variation of a sample difference.

Also, although a case has been described above with the embodiment where encoded information is transmitted from the encoding side to the decoding side, the present invention is equally effective to a case where information encoded on the encoding side is stored in a storage medium. The present invention is equally effective to a case where audio signals are often accumulated and used in a memory or disk.

Also, although a case has been described above with the embodiment where two channels are used, the number of channels is not limited, and the present invention is equally effective in the case where many channels (e.g. 5.1 channels) are used. In this case, if channels having temporally different correlation with a fixed channel are identified, the present invention is directly applicable to this case.

Also, although a case has been described above with the embodiment where a monaural signal and a side signal are encoded, the present invention is not limited to this, and the present invention is equally effective to a method using only a monaural signal. By using the present invention, it is possible to correct and down-mix a phase difference, so that it is possible to provide a monaural signal of high quality which is substantially equivalent to an excitation.

Also, in the above embodiment, although the equation for converting the left channel signal and the right channel signal to a monaural signal and a side signal, can be represented by the matrix of following equation 6, the present invention is equally effective in a case where this matrix differs from equation 6. This is because the feature of the present invention of correcting a phase difference little by little and interpolating a blank area that occurs upon the correction, does not depend on features of the above matrix. Therefore, upon converting signals of many channels like 5.1 channels, although the order of matrix becomes much higher and the values become complex, the present invention is equally effective even in this case.

$$\begin{matrix}( Equation 6 ) & \\ ( \begin{matrix}M \\ S\end{matrix} ) = ( \begin{matrix}0.5 & 0.5 \\ 0.5 & - 0.5\end{matrix} ) ( \begin{matrix}L \\ R\end{matrix} ) & [ 6 ]\end{matrix}$$

Also, the above explanation is an example of the best mode for carrying out the present invention, and the scope of the present invention is not limited to this. The present invention is applicable to any systems as long as these systems include a stereo signal converting apparatus, stereo signal inverse-converting apparatus, encoding apparatus or decoding apparatus.

Also, the stereo signal encoding apparatus, stereo signal decoding apparatus, encoding apparatus or decoding apparatus according to the present invention can be mounted on a communication terminal apparatus and base station apparatus in a mobile communication system, so that it is possible to provide a communication terminal apparatus, base station apparatus and mobile communication system having the same operational effect as above.

Although a case has been described above with the embodiment as an example where the present invention is implemented with hardware, the present invention can be implemented with software. For example, by describing the algorithm according to the present invention in a programming language, storing this program in a memory and running this program by an information processing section, it is possible to implement the same function as the stereo signal converting apparatus or encoding apparatus according to the present invention.

Furthermore, each function block employed in the description of each of the aforementioned embodiment may typically be implemented as an LSI constituted by an integrated circuit. These may be individual chips or partially or totally contained on a single chip.

“LSI” is adopted here but this may also be referred to as “IC,” “system LSI,” “super LSI,” or “ultra LSI” depending on differing extents of integration.

Further, the method of circuit integration is not limited to LSI's, and implementation using dedicated circuitry or general purpose processors is also possible. After LSI manufacture, utilization of an FPGA (Field Programmable Gate Array) or a reconfigurable processor where connections and settings of circuit cells in an LSI can be regenerated is also possible.

Further, if integrated circuit technology comes out to replace LSI's as a result of the advancement of semiconductor technology or a derivative other technology, it is naturally also possible to carry out function block integration using this technology. Application of biotechnology is also possible.

The disclosure of Japanese Patent Application No. 2008-134140, filed on May 22, 2008, including the specification, drawings and abstract, is incorporated herein by reference in its entirety.

### INDUSTRIAL APPLICABILITY

The stereo signal converting apparatus, stereo signal inverse-converting apparatus and converting and inverse-converting methods according to the present invention are suitably used for mobile phones, IP telephones and television conference, and so on.

1. A stereo signal converting apparatus comprising:
an analyzing section that finds a timing difference where a correlation is the highest between a first channel signal and a second channel signal moved cyclically in a time domain, the first channel signal and the second channel signal forming a stereo signal;
a sliding section that cyclically moves the second channel signal in the time domain based on the timing difference;
a sum and difference calculating section that generates a monaural signal related to a sum of the first channel signal and the second channel signal moved cyclically, and a side signal related to a difference between the first channel signal and the second channel signal moved cyclically; and
a first encoding section that encodes the timing difference.

2. An encoding apparatus comprising:
the stereo signal converting apparatus according to claim 1;
a second encoding section that encodes a monaural signal generated in the stereo signal converting apparatus; and
a third encoding section that encodes a side signal generated in the stereo signal converting apparatus.

3. A stereo signal inverse-converting apparatus comprising:
a reconstructed signal generating section that generates a reconstructed signal of a first channel signal and a reconstructed signal of a second channel signal moved cyclically in a time domain, using a reconstructed monaural signal and a reconstructed side signal, the reconstructed monaural signal decoding encoded data of a monaural signal related to a sum of the first channel signal and the second channel signal moved cyclically, the first channel signal and the second channel signal forming a stereo signal, and the reconstructed side signal decoding encoded data of a side signal related to a difference between the first channel signal and the second channel signal moved cyclically;
an opposite-sliding section that cyclically moves the reconstructed signal of the second channel signal moved cyclically, in a temporally opposite direction; and
a first decoding section that decodes encoded data of information indicating a value cyclically moving the second channel signal.

4. A decoding apparatus comprising:
the stereo signal inverse-converting apparatus according to claim 3;
a second decoding section that decodes the encoded data of the monaural signal and generates the reconstructed monaural signal; and
a third decoding section that decodes the encoded data of the side signal and generates the reconstructed side signal.

5. A stereo signal converting method comprising:
an analyzing step of finding a timing difference where a correlation is the highest between a first channel signal and a second channel signal moved cyclically in a time domain, the first channel signal and the second channel signal forming a stereo signal;
a sliding step of cyclically moving the second channel signal in the time domain based on the timing difference;
a sum and difference calculating step of generating a monaural signal related to a sum of the first channel signal and the second channel signal moved cyclically, and a side signal related to a difference between the first channel signal and the second channel signal moved cyclically; and
a first encoding step of encoding the timing difference.

6. A stereo signal inverse-converting method comprising:
a reconstructed signal generating step of generating a reconstructed signal of a first channel signal and a reconstructed signal of a second channel signal moved cyclically in a time domain, using a reconstructed monaural signal and a reconstructed side signal, the reconstructed monaural signal decoding encoded data of a monaural signal related to a sum of the first channel signal and the second channel signal moved cyclically, the first channel signal and the second channel signal forming a stereo signal, and the reconstructed side signal decoding encoded data of a side signal related to a difference between the first channel signal and the second channel signal moved cyclically;
an opposite-sliding step of cyclically moving the reconstructed signal of the second channel signal moved cyclically, in a temporally opposite direction; and
a decoding step of decoding encoded data of information indicating a value cyclically moving the second channel signal.
